(19) United States
(12) Patent Application Publication
(10) Pub. No.: US 2025/0096292 A1
(43) Pub. Date: Mar. 20, 2025

(54) METHOD FOR ESTABLISHING A DEFINED STATE IN AN ELECTROCHEMICAL SYSTEM, DISCONNECTING DEVICE, AND POWER CONVERTER

(71) Applicant: SMA Solar Technology AG, Niestetal (DE)

(72) Inventors: Alexander Unru, Baunatal (DE); Jose Navaro, Petrer (ES); Michael Krug, Niestetal (DE); Andreas Kluger, Waldkappel (DE)

(21) Appl. No.: 18/964,845

(22) Filed: Dec. 2, 2024

Related U.S. Application Data
(63) Continuation of application No. PCT/EP2023/064212, filed on May 26, 2023.

(30) Foreign Application Priority Data
Jun. 2, 2022 (DE) 10 2022 113 897.6

(51) Int. Cl. H01M 8/04858; C25B 9/65; C25B 15/02; H01M 8/04537; H01M 8/04955; H02J 3/38

(52) U.S. Cl. CPC H01M 8/04932; C25B 9/65; C25B 15/02; H01M 8/04552; H01M 8/04902; H01M 8/04955; H02J 3/38; H02J 2300/30

(57) ABSTRACT

The disclosure relates to a method for establishing a defined state in an electrochemical system connected to an AC/DC converter via a switch disconnector to exchange electric power. At least one DC connection of the electrochemical system is connected to the AC/DC converter via the disconnecting switch. The method includes, in a first operating state, closing a first switch to establish an electric connection between the DC connections of the electrochemical system. The application additionally relates to a disconnecting device, a power converter, and to an assembly.

### REFERENCE TO RELATED APPLICATIONS

This Application is a Continuation of International Application number PCT/EP2023/064212, filed on May 26, 2023, which claims the benefit of German Application number 10 2022 113 897.6, filed on Jun. 2, 2022. The contents of the above-referenced Patent Applications are hereby incorporated by reference in their entirety.

### FIELD

The application relates to a method for establishing a defined state in an electrochemical system, which is connected via at least one disconnecting switch of a disconnecting device to an AC/DC converter for the exchange of electric power, and a disconnecting device comprising at least one disconnecting switch for connecting an electrochemical system to an AC/DC converter for exchanging electric power.

### BACKGROUND

Electrolyzers and power converters for connecting an electrolyzer to an alternating voltage network are known from the prior art. A disconnecting device can be arranged between an electrolyzer and an AC/DC converter of the power converter, via which a connection between the electrolyzer and the AC/DC converter can be established or disconnected as required via disconnecting switches. The power converter can therefore comprise the disconnecting device, in addition to the AC/DC converter. In this application, AC (alternating current) refers to alternating current/alternating voltage and DC (direct current) refers to direct current/direct voltage.

An electrolyzer refers to a device in which a chemical reaction, i.e., a substance conversion, is brought about with the aid of electrical current, so that for example electrolysis takes place. The electrolyzer can be used in particular for the electrolytic production of hydrogen and oxygen from water.

A fuel cell as a galvanic cell converts chemical reaction energy of a supplied fuel and an oxidizing agent into electrical energy. A fuel cell often refers to a hydrogen-oxygen fuel cell. Some fuel cells can also use fuels other than hydrogen, in particular methanol, butane or natural gas. Furthermore, fuel cells are known that can be operated reversibly and can therefore serve as electrolyzers.

In an electrochemical system, an energy conversion between electrical and chemical energy takes place. Fuel cells and electrolyzers are examples of electrochemical systems. The AC/DC converter connected to the electrochemical system can convert electrical power in both directions—depending on the desired direction of power exchange—i.e., as an inverter it can convert the direct current produced by a fuel cell into alternating current, or as a rectifier it can produce the direct current required to operate an electrolyzer from an alternating current.

The DC voltage of an electrolyzer can remain at a high value for a long time after the electrolysis has stopped, i.e., in particular after the production of hydrogen, for example, has stopped. Since discharging these systems, i.e., reducing the voltage to a level considered safe, e.g., less than 50 volts, can take several hours or even several days, any maintenance times on the electrolyzer can be very long.

Load resistors can be used to discharge an electrolyzer or a fuel cell. These are only used temporarily for discharging, and their installation on a charged electrolyzer or fuel cell is not without risks.

The publication GB 903426 A describes a method for the electrolytic production of insoluble metal hydroxide from metal electrodes in a suitable electrolyte by passing current between the electrodes. In the method, a gel film produced on the electrodes is elastically displaced from the surfaces of the electrodes before it is hardened and encrusted on the surfaces of the electrodes.

The publication DE 10 2021 101440 A1 describes a method for pre-charging an electrochemical load via a pre-charging circuit arranged between a DC source and the electrochemical load. In this case, the pre-charging circuit has a series circuit of a pre-charging resistor and a disconnecting switch, a further disconnecting switch being arranged in parallel with the pre-charging resistor or in parallel with the series connection of the pre-charging resistor and disconnecting switch. The method has a plurality of active time windows in which a power loss is produced at the pre-charging resistor that is above a nominal power of the pre-charging resistor. The method also has one or more inactive time windows during which the current is suppressed by the pre-charging resistor.

### SUMMARY

The application is directed to addressing the problem of improving the production of a defined state of the electrochemical system.

An electrochemical system can be connected to an AC/DC converter for the exchange of electric power via disconnecting switches of a disconnecting device. In this case, the disconnecting device has two DC inputs for connecting to the AC/DC converter, two DC outputs for connecting to the electrochemical system, and two current paths. Each of the two current paths in each case connects a DC input to a corresponding DC output of the disconnecting device. A disconnection switch is arranged in at least one of the two current paths, optionally also in each of the two current paths in one embodiment, so that at least one of the DC connections, optionally also each of the two DC connections in one embodiment, of the electrochemical system is connected to the AC/DC converter via a disconnecting switch. The disconnecting device further comprises a first switch via which an electrical connection can be established between the DC outputs.

A method for establishing a defined state in an electrochemical system comprises:
In a first operating state in which the at least one DC connection is electrically disconnected from the AC/DC converter, for example, by the open disconnecting switch: a) closing a first switch of the disconnecting device to establish an electrical connection between the DC connections of the electrochemical system.

In one embodiment, a power converter comprises the AC/DC converter and the disconnecting device. The first operating state, in which at least one of the DC connections of the electrochemical system is electrically disconnected from the AC/DC converter is, for example, the state when the at least one disconnecting switch of the disconnecting device is open. The first operating state may also exist when the electrochemical system is disconnected from the AC/DC converter, e.g., when the electrochemical system is no longer connected to the disconnecting device or when the electrochemical system is still connected to the disconnecting device, but the disconnecting device is no longer connected to the AC/DC converter.

In this first operating state, the first switch of the disconnecting device provided for this purpose is closed so that an electrical connection is established between the DC connections and thus a discharge of the electrochemical system is made possible or brought about. This allows a defined state of the electrochemical system to be established by discharging the electrochemical system via its now connected DC connections. This makes it possible to establish a touch-safe state of the connections of the electrochemical system, e.g., the electrolyzer, even if the electrochemical system would otherwise generate a voltage at its DC connections, for example, due to internal electrochemical processes that are not based on the actual operation of the electrolyzer. The method thus also allows for the safeguarding of a maintenance process on the electrochemical system, e.g., the electrolyzer.

The method thus makes it possible to solve at least the following problem: An electrochemical system, for example, an electrolyzer or a fuel cell, can generate a significant DC voltage during certain process steps, on its own and without supply via a power converter, even if there is no connection to an alternating voltage network, for example, even if there is no supply via the power converter or no power exchange with the AC/DC converter of the power converter. An example of such a process act is when an electrolyzer is rinsed with clean water. This can be done after each maintenance of the electrolyzer and/or before each hydrogen production, the electrolyzer in this case being in the first operating state, i.e., disconnected from the AC/DC converter. In this case, the DC voltage at the connections of the electrolyzer can rise to over 50 V (i.e., above the protective extra-low voltage of 50 V). This phenomenon was previously unknown. This (unexpected) voltage can also be present on the DC connections within the power converter, i.e., also within its housing, for example, on the DC lines that establish the electrical connection from the disconnecting device to the electrolyzer or fuel cell. The voltage produced at the electrolyzer during such a process can be high and can therefore pose a danger, for example, if, due to the separation of the connection between the electrolyzer and the alternating voltage network, it is incorrectly assumed that the DC connections of the electrolyzer are largely de-energized.

The method described makes it possible in one embodiment to bring the electrochemical system into a defined state and, for example, into a safe state, in which, for example, maintenance can be carried out safely and unexpectedly occurring electrical charges at the DC connections can be discharged via the closed first switch. In this way, a voltage that would otherwise occur at the DC connections of the electrochemical system due to the electrical charges is prevented, or at least reduced to a value that excludes any danger to persons. This thus makes it possible to establish a safe operating state during maintenance work on an electrochemical system, e.g., an electrolyzer or a fuel cell.

Sometimes it may be desirable to use the disconnecting device to disconnect the electrochemical system from the AC/DC converter in only one pole. This may be the case, for example, if the electrochemical system has a ground at one of its DC connections, either the positive or the negative DC connection. In these cases, it may be advantageous if the current path of the disconnecting device which is connected to the grounded DC connection during normal operation of the electrochemical system does not have a disconnecting switch, and a disconnecting switch is arranged only in the corresponding other current path. Alternatively, in contrast thereto, it may be desirable to completely disconnect the electrochemical system from the AC/DC converter. For this purpose, a disconnecting switch can be arranged in one embodiment in each of the two current paths of the disconnecting device, which switch is designed to disconnect the corresponding DC input from the DC output assigned thereto. This is the case, for example, if the electrochemical system has a grounding point located between both of its DC connections. Such a point may be a voltage center of the electrochemical system, so that the electrochemical system has a center ground.

In one embodiment of the method, act a) is divided as follows:
a.1) before closing the first switch: measuring a voltage between the DC connections
a.2) when the measured voltage falls below a predefined first threshold value: closing the first switch.

This embodiment ensures that the voltage between the DC connections is not too high when the first switch is closed. For example, the first threshold value can be 50 V. This would mean that the first switch is, in one embodiment, only closed when the protective extra-low voltage falls below 50 V or some predetermined threshold value. This allows the first switch to be closed safely. At the same time, safe maintenance of the electrochemical system can be carried out with the first switch closed. The closed first switch prevents a voltage build-up between the two DC connections of the electrochemical system, which can be dangerous, for example, if it is unexpected.

In one embodiment of the method, the DC connections are short-circuited by closing the first switch. The provision of the first switch in the disconnecting device allows the first switch to serve as a short-circuit switch, by means of which a defined, safe operating state of the electrochemical system, e.g., the electrolyzer, can be brought about by short-circuiting the two DC connections of the electrochemical system. The short circuit creates a defined state in which no voltage can build up between the two connections.

The proposed solution thus offers the possibility of a safe short circuit of the electrochemical system with low circuit complexity, and is therefore cost-effective. Additional effort to perform a short circuit directly on the electrochemical system is avoided because the first switch is provided within the disconnecting device. The additional connections that would otherwise be required for a short circuit on the electrochemical system itself can be avoided. At the same time, such a short circuit can be carried out in a manner that is gentle on the electrochemical system as well as safe for the entire system including the power converter with AC/DC converter and disconnecting device.

In this embodiment, the proposed solution provides an advantageous galvanic separation between the electrochemical system and the AC/DC converter by first disconnecting the AC/DC converter and then short-circuiting the electrochemical system. Maintenance work on the electrochemical system can then be carried out in a safe state. When performing maintenance work on the AC/DC converter, it may be sufficient to ensure galvanic separation of the AC/DC converter from the electrochemical system, since the AC/DC converter may already provide fuses internally.

In one embodiment of the method, the DC connections are connected via an ohmic resistor by closing the first switch, and the electrochemical system is discharged via the ohmic resistor. This embodiment allows the DC connections to be connected safely even if there is a higher voltage at the DC connections, and allows the electrochemical system to be safely discharged via the first switch and the ohmic resistor. The flowing discharge current is limited by the ohmic resistor.

In one embodiment, the disconnecting device comprises a pre-charging circuit in at least one current path connecting a DC input to a corresponding DC output of the disconnecting device. The pre-charging circuit may comprise a series circuit of a pre-charging resistor and a pre-charging switch. The series circuit can be arranged in parallel with the disconnecting switch in the relevant current path, so that the pre-charging resistor can be bridged with low resistance by the closed disconnecting switch. For pre-charging the electrochemical system, the relevant DC connection of the electrochemical system can therefore be connected to the AC/DC converter via the pre-charging resistor and the pre-charging switch. This can be done with the disconnecting switch of the relevant current path open, so that the pre-charging resistor has a current-limiting effect when pre-charging the electrochemical system. When the pre-charging of the electrochemical system has progressed sufficiently, the series circuit of pre-charging resistor and pre-charging switch can be bridged by closing the disconnecting switch in the relevant current path, and the relevant DC input can be connected to the DC output assigned to it in a low-impedance manner. In this case, the ohmic resistor via which the electrochemical system is discharged may comprise at least one of the pre-charging resistors. For example, the ohmic resistor via which the electrochemical system is discharged can be designed as one of the pre-charging resistors. The provision of the first switch as part of the disconnecting device and the provision of the ohmic resistor as part of the pre-charging circuit of the disconnecting device allows the first switch to serve as the switch via which the DC connections of the electrochemical system are connected, and one of the pre-charging resistors to serve as the resistor via which the electrochemical system is discharged. This embodiment offers a simple structure and reduces the circuit complexity, since the pre-charging resistor already present in the pre-charging circuit can be used as a resistor for discharging the electrochemical system. The advantage of the lower circuit complexity also arises, for example, when the disconnecting device has in each case a pre-charging circuit with a pre-charging switch and a pre-charging resistor arranged in series with it in each of the two current paths, so that each of the two DC connections of the electrochemical system can in each case be connected to the AC/DC converter via a pre-charging resistor and a pre-charging switch for pre-charging the electrochemical system. Specifically, in this embodiment, the ohmic resistor via which the electrochemical system is discharged can comprise one or both of the two pre-charging resistors. This can be the case, for example, in an electrochemical system that has a center ground.

In an embodiment of the method in which a pre-charging circuit comprising a pre-charging switch and a pre-charging resistor arranged in series therewith is arranged in each of the two current paths, the two pre-charging resistors can also have different resistance values, for example, resistance values that differ by one order of magnitude or by several orders of magnitude. Specifically, one of the pre-charging resistors can be low-resistance and another high-resistance. In this way, the electrochemical system can be pre-charged via a low-resistance of the two pre-charging resistors, while the electrochemical system can be discharged via a high-resistance of the two pre-charging resistors.

In one embodiment of the method, act a) is followed by act b) in which a second switch is closed to short-circuit the DC connections. In this embodiment, the first switch is first closed, and the electrochemical system is discharged via the ohmic resistor. Thereafter, the second switch is closed and the electrochemical system is short-circuited via the second switch. This has the advantage that the electrochemical system can first be discharged and then short-circuited. This means that the system is always in a defined state and, after closing the second switch, in a safe state with short-circuited DC connections.

In one embodiment of the method, act b) is divided as follows:
b.1) before closing the second switch: measuring the voltage between the DC connections
b.2) when the measured voltage falls below a predefined second threshold value: closing the second switch.

In this embodiment, in act b.1) it can be checked, by measuring the voltage between the DC connections, whether the electrochemical system has already been discharged sufficiently via the ohmic resistor to be able to safely close the second switch in b.2). This further increases the safety of the method.

In one embodiment of the method, the first operating state is established by opening the disconnecting switches and/or by disconnecting the disconnecting device from the AC/DC converter. This act for assuming the first operating state advantageously precedes the previously described act a), so that the electrochemical system is electrically disconnected from the AC/DC converter when the first switch of the disconnecting device is closed, in act a), for establishing an electrical connection between the DC connections of the electrochemical system.

The proposed solution allows the disconnecting device to be used to establish the safe state. This thus makes it possible to omit additional galvanic separation between the electrolyzer or fuel cell and the AC/DC converter, which would involve additional effort and costs. In addition, the AC/DC converter is already fully disconnected on the DC side, via which the first operating state can be established.

In a second operating state, the electrochemical system is connected to the disconnecting device and thus is connected to the AC/DC converter. When the disconnecting switches of the disconnecting device are closed, an electrolyzer, for example, can be supplied with electric power via the AC/DC converter from an AC source, for example, from an AC network. Alternatively or additionally, for example, a fuel cell can thus exchange electrical power with an AC sink, for example, with the AC network, via the AC/DC converter when the disconnecting switches of the disconnecting device are closed.

In one embodiment, the method comprises: in the second operating state, in which the DC connections are electrically connected to the AC/DC converter via the closed disconnecting switch(es):
c) exchanging electric power of the electrochemical system with the AC/DC converter, and
d) establishing the first operating state by opening one or each of the disconnecting switches.

In this embodiment, it is thus possible to change from the second operating state to the first operating state by opening one or each of the disconnecting switches of the disconnecting device. In the first operating state, for example, the electrochemical system can be discharged via the ohmic resistor by closing the first switch, and then a short circuit can be established between the DC connections by closing the second switch. In this safe state, for example, maintenance of the electrochemical system can then be carried out.

In one embodiment of the method, a pre-charging operating state precedes the second operating state. In the pre-charging operating state, the electrochemical system can be charged via one of the pre-charging resistors when the pre-charging switch is closed. If the disconnecting device has a pre-charging circuit with a pre-charging switch and a pre-charging resistor in each of its two current paths, it is also possible for the electrochemical system to be charged via the pre-charging resistors in the pre-charging operating state with two pre-charging switches closed. During pre-charging, the electrochemical system is supplied with electric power for a period of time via the pre-charging resistors, and is thus pre-charged.

In this embodiment, a start can be carried out, for example, such that the electrochemical system is connected to the AC/DC converter for example, via the disconnecting device, and both the pre-charging switch(es) and the disconnecting switch(es) are open. The electrochemical system can then initially be pre-charged via the pre-charging circuit or circuits by closing the present pre-charging switches. Once the pre-charging is complete, the second operating state can be entered by closing the disconnecting switch(es). In this case, the pre-charging switch(es) can be opened again, but this is not mandatory. The second operating state may, for example, comprise a normal operation of the electrochemical system and may last for some time, for example, a few hours or days.

In one embodiment, in order to terminate normal operation as required, it is possible to switch from the second operating state to the first operating state by opening the disconnecting switch(es) of the disconnecting device. In the first operating state, for example, the electrochemical system can be discharged via the ohmic resistor by closing the first switch, and then a short circuit can be created between the DC connections by closing the second switch. In this safe state, for example, maintenance of the electrochemical system can then be carried out.

In one embodiment of the method, the first switch and/or the second switch, if present, may comprise a normally closed switch. A “normally closed switch,” or also called a “normally closed contact,” is a switch that assumes a closed state and/or remains in a closed state on its own and without a control signal applied to the switch. Furthermore, the open state of the switch is only brought about by a control signal applied to the switch. It must therefore be opened actively, usually with the expenditure of energy. An embodiment of the first switch as a normally closed switch, and if applicable also of the second switch as a normally closed switch, is advantageous, for example, when an assembly comprising the electrochemical system and a power converter for supplying the electrochemical system has an emergency shutdown device. Such an emergency shutdown device is intended to ensure that, when it is activated, an input-side power exchange between the power converter of the assembly and the network is safely prevented and, in addition, that the electrochemical system of the assembly assumes a safe state. Usually, when the emergency shutdown device is activated, the actuation of components of the assembly is also deliberately prevented. It is thus possible that after the emergency shutdown is triggered, active actuation of the switches on the disconnecting device is also prevented and can no longer take place. However, since the first switch and, if applicable, also the second switch are designed as normally closed switches, each of these switches assumes the closed state after the emergency shutdown device is activated. Specifically, in one embodiment of the method, the first switch and/or the second switch, if present, can each be coupled to an emergency shutdown device such that each of these switches assumes its normally closed state in response to actuation of the emergency shutdown device. In this case, the second switch can also have a voltage monitor or a time delay element associated therewith. This ensures that in one embodiment the second switch only assumes its normally closed state with a time delay compared to the first switch and that premature hard short-circuiting of both DC connections, i.e., when a significant DC voltage is still present, and the associated high short-circuit current, can be prevented. In this way, the electrochemical system can be safely discharged and/or short-circuited even if the first switch and, if applicable, also the second switch, of the disconnecting device are no longer actuated.

In a disconnecting device comprising disconnecting switches for connecting an electrochemical system to an AC/DC converter for exchanging electric power, in each case a DC output of the disconnecting device can be connected to a DC connection of the electrochemical system. The disconnecting device further comprises a first switch via which an electrical connection can be established between the DC outputs.

In one embodiment of the disconnecting device, the DC outputs can be connected via an ohmic resistor by closing the first switch. In this case, the disconnecting device is designed to discharge the electrochemical system connected to the DC outputs via the ohmic resistor when the first switch is closed.

The disconnecting device has DC inputs that can be connected to the AC/DC converter. In one embodiment, the disconnecting device has a pre-charging circuit via which the DC outputs can in each case be connected to the DC inputs via a pre-charging resistor and a pre-charging switch for pre-charging the electrochemical system. In this case, the ohmic resistor via which the electrochemical system can be discharged comprises at least one of the pre-charging resistors. In one embodiment, the ohmic resistor via which the electrochemical system can be discharged is one of the pre-charging resistors.

An assembly according to the disclosure comprises the power converter, the electrochemical system, and a system controller for controlling the assembly. In this case, the system controller is an information processing system that is designed and configured to carry out the method described above.

### BRIEF DESCRIPTION OF THE FIGURES

The disclosure is further explained and described below with reference to example embodiments illustrated in the figures.

FIGS. 1, 2a, 2b, 3a and 3b show different embodiments of a power converter with an electrochemical system.

The same reference signs are used in the figures for identical or similar elements.

### DETAILED DESCRIPTION

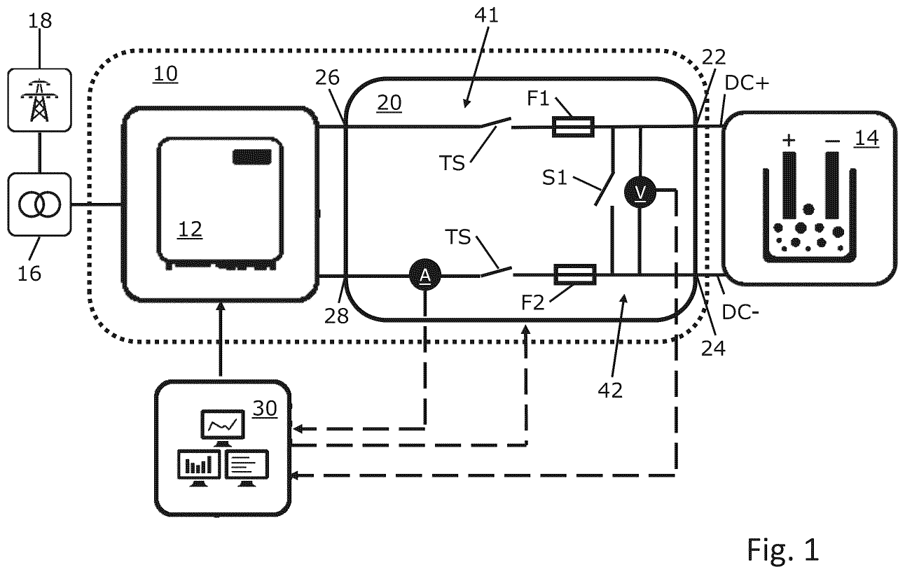

FIG. 1 schematically shows an electrochemical system 14, e.g., an electrolyzer or a fuel cell, which is connected to an AC network 18 via a power converter 10 and a transformer 16. The AC network 18 is, for example, an alternating voltage network of an energy supplier. The power converter 10 has an AC/DC converter 12 and a disconnecting device 20. The AC/DC converter 12 has a clocked semiconductor circuit and can convert alternating voltage into direct voltage or alternating current into direct current and vice versa. The semiconductor circuit of the AC/DC converter 12 is controlled by a system controller 30. The system controller 30 may be part of the power converter 10 and includes hardware such as a processor and memory and is configured and adapted to execute computer program instructions of a software. The electrochemical system 14 is connected to the AC/DC converter 12 via the disconnecting device 20.

The disconnecting device 20 has two current paths 41, 42, each connecting a DC input 26, 28 to a DC output assigned to the DC input 26, 28. In this case, the disconnecting device 20 illustrated in FIG. 1 is designed by way of example with all poles, i.e., it has a disconnecting switch TS in each case for each of the DC connections of the electrochemical system, i.e., in each of its two current paths 41, 42. In the example shown, both DC connections DC+, DC− of the electrochemical system 14 are in each case connected to one pole, i.e., a DC output 22, 24, of the disconnecting device 20. Each DC connection DC+, DC− of the electrochemical system 14 can be connected to or disconnected from the AC/DC converter 12 via the corresponding disconnecting switch TS. Each of the disconnecting switches TS is optionally protected by a fuse F1, F2. The corresponding DC inputs 26, 28 of the disconnecting device are each connected to a DC-side connection of the AC/DC converter.

When the disconnecting switches TS are open, the electrochemical system 14 is completely disconnected from the AC/DC converter 12. This corresponds to a first operating state of an assembly comprising the electrochemical system 14 and the power converter 10.

In the first operating state, the voltage between the DC connections DC+ and DC− can be measured via the voltmeter V and monitored by the system controller 30. In the first operating state, the electrochemical system 14 is discharged. Depending on the state of charge, this may take some time, e.g., a few hours or a few days. The voltmeter V can be used to detect the state of charge of the electrochemical system 14 and to determine whether a state of charge has been reached in which a first switch S1 can be safely closed. This is the case, for example, when the protective extra-low voltage falls below 50 V. Such detection of the state of charge and such closing of the first switch S1 can be controlled, for example, by the system controller 30. After closing the first switch S1, the electrochemical system 14 can be safely serviced. Even if the electrochemical system 14 should generate an unexpected DC voltage at its DC connections DC+ and DC− and thus possibly also within the electrochemical system 14, this voltage is reduced by the safe (external) connection of the DC connections DC+ and DC− via the closed first switch S1.

When the disconnecting switches TS are closed, an exchange of electric power can take place between the electrochemical system 14, via the power converter 10 and the transformer 16, with the AC network 18. This corresponds to a second operating state of the assembly. In the second operating state, the current flowing during the exchange of electric power can be measured via the ampere meter A and evaluated by the system controller 30 in order, for example, to avoid exceeding a maximum value.

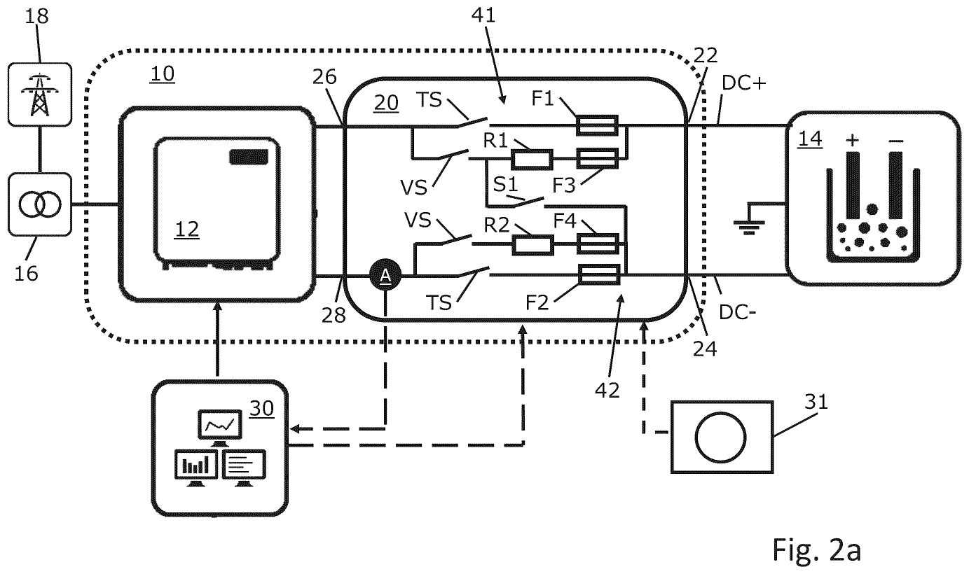

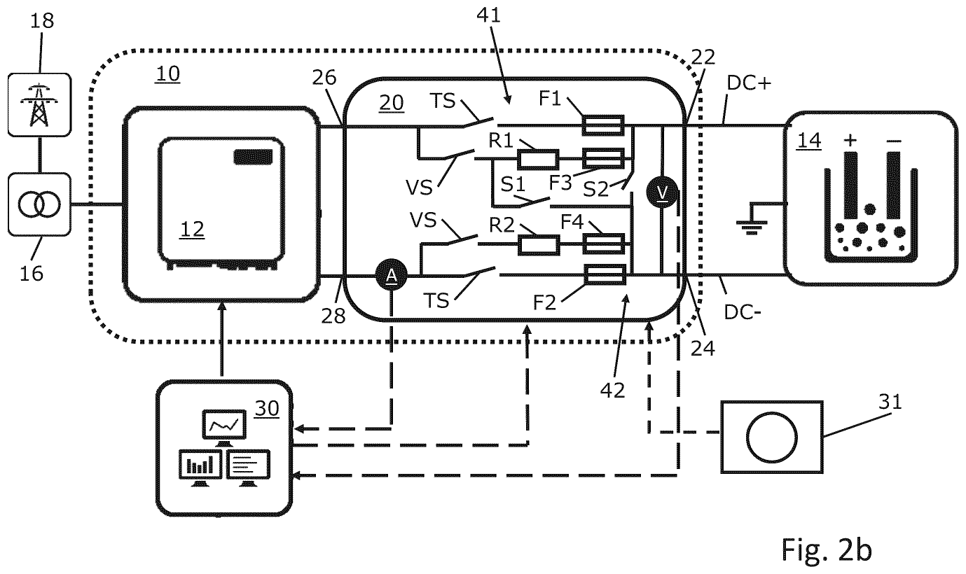

In the embodiment shown in FIG. 2a, the disconnecting device 20 is equipped with an all-pole DC pre-charging unit. In this case, in each of the current paths 41, 42 of the disconnecting device 20 a pre-charging circuit having a series circuit of a pre-charging switch VS and a pre-charging resistor R1, R2 is arranged in parallel with the disconnecting switch TS and the optional fuse F1. Each of the two poles, i.e., each of the two DC connections DC+, DC− of the electrochemical system 14, is connected to one of the DC outputs 22, 24 of the disconnecting device 20. Each of the pre-charging circuits comprises one of the pre-charging resistors R1, R2 in each case, via which the electrochemical system 14 can be charged when the pre-charging switches VS are closed. Each of the pre-charging circuits is optionally protected by fuses F3, F4. The pre-charging circuits of the disconnecting device 20 can be used, for example, to pre-charge an electrolyzer to an open circuit voltage of the AC/DC converter 12 before the disconnecting switches TS are closed and power is exchanged via the power converter, so that, for example, hydrogen production takes place.

In the example shown, the disconnecting device 20 comprises the first switch S1. In FIG. 2a, the first switch S1 is connected, by way of example, with one of its contacts, to a connection point between the pre-charging switch VS and the pre-charging resistor R1 of the pre-charging circuit assigned to the positive current path 41, while the second contact is connected to the negative DC output 24 of the disconnecting device. Alternatively, it is also possible that the first switch S1 is connected with one of its contacts to the connection point between the pre-charging switch VS and the pre-charging resistor R2 of the pre-charging circuit assigned to the negative current path 42, while the second contact is connected to the positive DC output 22 of the disconnecting device 20 (not shown in FIG. 2a). Finally, it is also possible that the first switch S1 is connected with one of its contacts to the connection point between the pre-charging switch VS and the pre-charging resistor R1 of the pre-charging circuit assigned to the positive current path 41, while its other contact is connected to the connection point between the pre-charging switch VS and the pre-charging resistor R2 of the pre-charging circuit associated with the negative current path 42 (not shown in FIG. 2a). When the disconnecting switches TS and the pre-charging switches VS are open, a safe operating state of the electrochemical system 14, e.g., for maintenance purposes, can be initiated by closing the first switch S1. In this case, the two DC outputs 22, 24 and associated DC connections DC+, DC− are connected to each other via the pre-charging resistor R1, via the pre-charging resistor R2 or via a series circuit of the pre-charging resistors R1 and R2, depending on the arrangement of the first switch S1. The electrochemical system 14 can discharge via the corresponding pre-charging resistor R1, R2 or the pre-charging resistors R1 and R2 and, if unexpected voltages occur at the DC connections DC+, DC−, these can be reduced via the corresponding pre-charging resistor R1, R2 or the pre-charging resistors R1 and R2.

Optionally, an intermediate circuit of the AC/DC converter 12 can also be discharged via the pre-charging circuits shown in FIG. 2a. For this purpose, in addition to the first switch S1, the pre-charging switches VS can also be closed, so that the intermediate circuit of the AC/DC converter 12 is discharged via the pre-charging resistor R2. The switches TS, VS and/or S1 can be actuated, for example, by the system controller 30.

An all-pole-separating disconnecting device 20 comprising in each case one disconnecting switch TS and one pre-charging circuit in each of the current paths 41, 42 is advantageous in one embodiment when the electrochemical system 14 has, as symbolized in FIG. 2a, a center ground.

The assembly can additionally have an optional emergency shutdown device 31 which, when actuated, is designed to disconnect the AC/DC converter on the AC side and the DC side, i.e., to disconnect it on the AC side from the AC network and on the DC side from the electrochemical system 14. In this case, it may be necessary for the electrochemical system 14 to additionally be safely discharged, even if actuation of the disconnecting device 20 by the system controller unit 30 is prevented due to the operation of the emergency shutdown device 31. In order to nevertheless achieve a safe discharge of the electrochemical system 14, the first switch S1 can be designed as a normally closed switch which assumes its closed state on its own, i.e., in the absence of an actuation signal. In this case, the first switch S1 is coupled to the emergency shutdown device 31 in such a way that when the emergency shutdown device 31 is operated it assumes its normally closed state and discharges the electrochemical system 14.

In the embodiment shown in FIG. 2b, the disconnecting device 20 comprises, in addition to the first switch S1, a second switch S2 and optionally the voltmeter V.

When the disconnecting switches TS and the pre-charging switches VS are open, a safe operating state of the electrochemical system 14, e.g., for maintenance purposes, can be initiated by closing the first switch S1. In this case, the two DC outputs 22, 24 and the associated DC connections DC+, DC− are connected to each other via the pre-charging resistor R1. The electrochemical system 14 can discharge via the pre-charging resistor R1.

The voltmeter V can be used to measure the voltage between the DC outputs 22, 24 and thus determine whether and to what extent an electrochemical system 14 connected to the DC outputs 22, 24 is (still) charged. If the voltage measured by the voltmeter V is small enough, e.g., below a predefined threshold value of, for example, 50 V, the second switch S2 can be closed. In this case, the voltage at the electrochemical system 14 can optionally be reduced by discharging via the pre-charging resistor R1. By closing the second switch S2, the DC outputs 22, 24 are short-circuited and, if unexpected voltages occur at the DC connections DC+, DC-connected to the DC outputs 22, 24, these can be directly reduced via the short circuit.

The actuation of the switches TS, VS, S1 and/or S2 as well as the measurement of the voltage by means of the voltmeter V and the determination of the state of charge of the electrochemical system 14 connected to the DC outputs 22, 24 can be carried out, for example, by the system controller 30.

The second switch S2 can also be designed as a normally closed switch S1 in one embodiment, analogously to the first switch S1. It can also have an independently operating time delay element or an independently operating voltage monitor. This ensures that the second switch S2 assumes its normally closed state after the first switch S1 or when the voltage falls below a predefined voltage. This is advantageous in one embodiment if the assembly has an emergency shutdown device 31, the first switch S1 and the second switch S2 being coupled to the emergency shutdown device 31 in such a way that they assume their normally closed state when the emergency shutdown device 31 is operated.

In one embodiment, the addition of the described discharge function and the described short-circuit function to the pre-charging circuit offers the advantage that system costs and maintenance costs can be significantly reduced as a result.

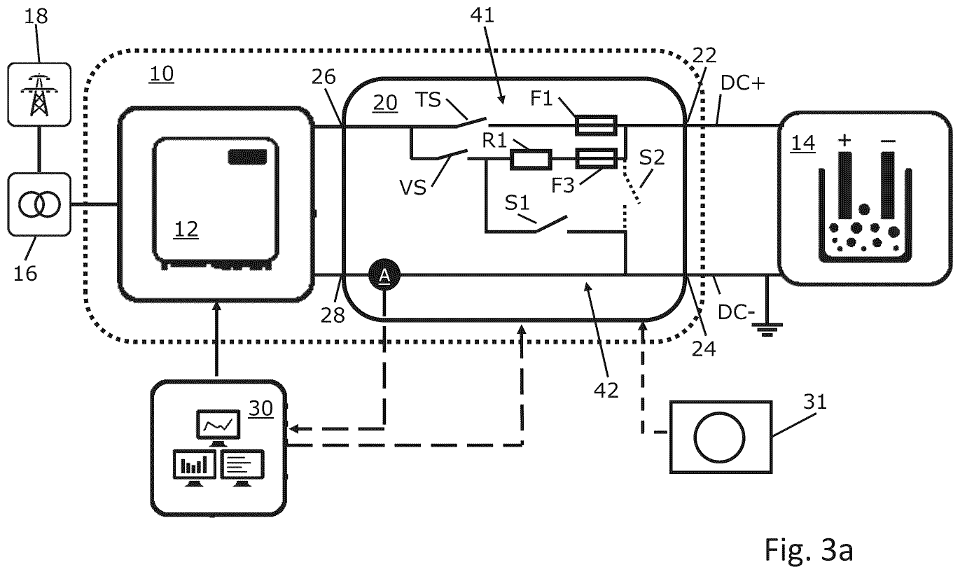

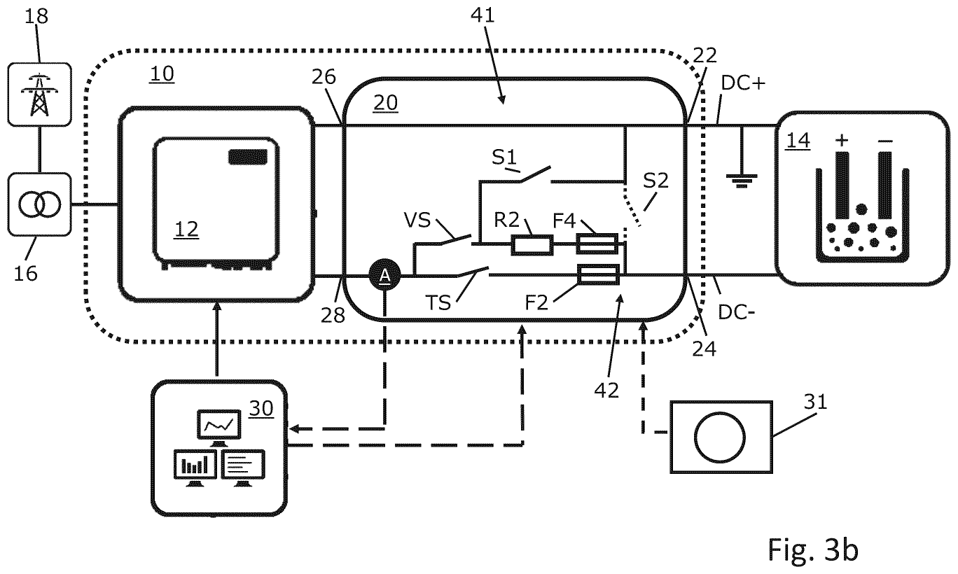

FIGS. 3a and 3b show further embodiments of an assembly, in which an electrochemical system 14 is connected to an AC network 18 via a power converter 10, comprising an AC/DC converter 12 and a disconnecting device 20, and a transformer 16. The embodiments in FIGS. 3a and 3b are similar in many features to the embodiment shown in FIG. 2b. Therefore, mainly the differences from the embodiment in FIG. 2b are explained below, while for the identical features reference is made to the figure description of FIG. 2b.

In contrast to FIGS. 2a and 2b, the disconnecting device in FIG. 3a has only a single-pole separation with a disconnecting switch TS in the positive current path 41. The negative current path 42 is free of a disconnecting switch TS. In addition, a pre-charging circuit comprising a pre-charging switch VS and a pre-charging resistor R1 is also arranged only between the positive DC input 26 and the positive DC output 22, which is therefore assigned to the positive current path 41. The disconnecting device 20 also has a first switch S1 which connects a connection point between the pre-charging switch VS and the pre-charging resistor R1 of the pre-charging circuit, assigned to the positive current path 41, to the negative DC output 24. The disconnecting device 20 can optionally also comprise in one embodiment the second switch S2, which can short-circuit the two DC outputs 22, 24 of the disconnecting device 20, and thus the DC connections DC−, DC+ of the electrochemical system 14. In FIG. 3a, the optional second switch S2 and its arrangement are symbolized by dashed lines. The second switch S2 can also be designed analogously to the first switch S1 as a normally closed switch in one embodiment, which assumes its closed state on its own, i.e., in the absence of an actuation signal. In one embodiment, the second switch S2 may additionally comprise an (independently operating) time delay element or an independently operating voltage monitor (not shown in FIG. 3a). This ensures that the second switch S2 only assumes its normally closed state after the first switch S1, for example, after a preset period of time has elapsed or when the voltage falls below a preset voltage. Such a single-pole-separating disconnecting device 20 comprising a pre-charging circuit assigned to the positive current path 41 is advantageous in one embodiment when the electrochemical system 14 has a ground at its negative DC connection.

The embodiment in FIG. 3b differs from that in FIG. 3a in that the disconnecting switch TS and the pre-charging circuit of the pre-charging switch VS and pre-charging resistor R2 are arranged between the negative DC input 28 and the negative DC output 24 of the disconnecting device 20, and are therefore assigned to the negative current path 42 of the disconnecting device 20. The first switch S1 here connects a connection point between the pre-charging switch VS and the pre-charging resistor R2 of the pre-charging circuit with the positive DC output 22 of the disconnecting device 20 and thus with the positive DC connection DC+ of the electrochemical system 14. Such a single-pole-separating disconnecting device 20 comprising a pre-charging circuit assigned to the negative current path 42 is advantageous in one embodiment when the electrochemical system 14 has a ground at its positive DC connection DC+.

What is claimed is:

1. A method for establishing a defined state in an electrochemical system which is configured to be connected via a disconnecting device to an AC/DC converter for exchanging electric power,
wherein the disconnecting device has two DC inputs, two DC outputs and two current paths, wherein each current path connects a respective DC input to a corresponding DC output, and wherein the disconnecting device comprises a disconnecting switch arranged in at least one of the two current paths, so that at least one DC connection of the electrochemical system is connected to the AC/DC converter via the disconnecting switch of the disconnecting device, the method comprising:
in a first operating state in which the at least one DC connection is electrically disconnected from the AC/DC converter by the disconnecting switch being open:
a) closing a first switch of the disconnecting device to establish an electrical connection between the at least one DC connection.

2. The method according to claim 1, wherein the disconnecting device comprises two disconnecting switches, wherein in each case one of the two disconnecting switches is arranged in a respective one of the two current paths, so that each DC connection of the electrochemical system is selectively connected to the AC/DC converter via one of the two disconnecting switches,
wherein in the first operating state in which act a) takes place, each of the DC connections is electrically disconnected from the AC/DC converter by opening a respective disconnecting switch.

3. The method according to claim 1, wherein act a) is divided as follows:
a.1) before closing the first switch, measuring a voltage between the DC connections, and
a.2) when the measured voltage falls below a predefined first threshold value, closing the first switch.

4. The method according to claim 3, wherein the DC connections are short-circuited by closing the first switch.

5. The method according to claim 1, wherein the DC connections are connected via an ohmic resistor by closing the first switch and the electrochemical system is discharged via the ohmic resistor.

6. The method according to claim 5, wherein the disconnecting device comprises a pre-charging circuit with a pre-charging switch and a pre-charging resistor in at least one current path, wherein at least one DC connection of the electrochemical system is connected to the AC/DC converter via the pre-charging resistor and the pre-charging switch for pre-charging the electrochemical system, and wherein the ohmic resistor via which the electrochemical system is discharged comprises the pre-charging resistor.

7. The method according to claim 5, wherein the disconnecting device comprises a pre-charging circuit with a pre-charging switch and a pre-charging resistor in each of the two current paths, wherein each DC connection of the electrochemical system are connected to the AC/DC converter via a pre-charging resistor in each case and a pre-charging switch in each case for pre-charging the electrochemical system, and wherein the ohmic resistor via which the electrochemical system is discharged comprises one or two of the pre-charging resistors.

8. The method according to claim 5, comprising, after act a):
b) closing a second switch to short-circuit the DC connections.

9. The method according to claim 8, wherein act b) comprises:
b.1) before closing the second switch, measuring a voltage between the DC connections, and
b.2) when the measured voltage falls below a predefined second threshold value, closing the second switch.

10. The method according to claim 5, wherein the first operating state is established by opening the disconnecting switch and/or by disconnecting the disconnecting device from the AC/DC converter.

11. The method according to claim 10, further comprising:
in a second operating state in which the DC connections are electrically connected to the AC/DC converter via the disconnecting switch or switches:
c) exchanging electric power of the electrochemical system with the AC/DC converter, and
d) establishing the first operating state by opening one or each of the disconnecting switches.

12. The method according to claim 11, wherein the second operating state is preceded by a pre-charging operating state,
in which the electrochemical system is charged via one of the pre-charging resistors when a pre-charging switch is closed, or
in which the electrochemical system is charged via the pre-charging resistors when two pre-charging switches are closed.

13. The method according to claim 8, wherein the first switch and/or the second switch comprises a normally closed switch.

14. The method according to claim 13, wherein the first switch and/or the second switch is coupled to an emergency shutdown device.

15. A disconnecting device comprising one or two disconnecting switches for connecting an electrochemical system to an AC/DC converter for exchanging electric power, wherein the disconnecting device has two DC inputs, two DC outputs and two current paths, wherein each current path connects a DC input in each case to a corresponding DC output, and wherein a disconnecting switch is arranged in one or each of the current paths, wherein in each case a DC output of the disconnecting device can be connected to a DC connection of the electrochemical system, and wherein the disconnecting device further comprises a first switch via which an electrical connection between the DC outputs can be established.

16. The disconnecting device according to claim 15, wherein the DC outputs are connected via an ohmic resistor by closing the first switch, and wherein the disconnecting device is configured to discharge the electrochemical system connected to the DC outputs via the ohmic resistor when the first switch is closed.

17. The disconnecting device according to claim 16, wherein the disconnecting device comprises a pre-charging circuit in at least one of its current paths, so that at least one of the DC outputs is selectively connected to a corresponding one of the DC inputs via a pre-charging resistor and a pre-charging switch for pre-charging the electrochemical system, and wherein the ohmic resistor via which the electrochemical system is discharged comprises the pre-charging resistor.

18. The disconnecting device according to claim 16, wherein the disconnecting device comprises a pre-charging circuit in each of its two current paths, so that each of the DC outputs are connected to the corresponding one of the DC inputs via a pre-charging resistor and a pre-charging switch for pre-charging the electrochemical system, and wherein the ohmic resistor via which the electrochemical system is discharged comprises one or two of the pre-charging resistors.

19. A power converter comprising an AC/DC converter and a disconnecting device according to claim 15.

20. An assembly comprising an electrochemical system and a power converter according to claim 19.
